(19) United States
(12) Patent Application Publication
(10) Pub. No.: US 2010/0153172 A1
(43) Pub. Date: Jun. 17, 2010

(54) Interactive Analysis and Reporting System for Telecom and Network Industry Data

(76) Inventor: Ray Mota, Reno, NV (US)

Correspondence Address: JUNEAU PARTNERS, 333 N Fairfax St., Suite 305, ALEXANDRIA, VA, 22301, US

(21) Appl. No.: 12/244,690

(22) Filed: Oct. 2, 2008

(51) Int. Cl. G06Q 10/00

(52) U.S. Cl. 705/10

(57) ABSTRACT

This invention relates to a method and system for providing a subscriber with secure access to a custom market share research environment for viewing quantitative market share data stored in a database on the server, and for generating real-time customized interactive reports of said data based parameters such as quarterly data, yearly data, date-range presented data, individual company data, market segment data, entire market data, geographical region data, country data, revenue data, units data, and user-defined data.

### STATEMENT REGARDING FEDERALLY SPONSORED RESEARCH OR DEVELOPMENT

No federal government funds were used in researching or developing this invention.

### CROSS REFERENCE TO RELATED APPLICATIONS

Not applicable.

### NAMES OF PARTIES TO A JOINT RESEARCH AGREEMENT

Not applicable.

### REFERENCE TO A SEQUENCE LISTING

Not applicable.

### BACKGROUND

1. Field of the Invention

This invention relates to a method and system for providing a subscriber with secure access to a custom market share research environment for viewing quantitative market share data stored in a database on the server, and for generating real-time customized interactive reports of said data based parameters such as quarterly data, yearly data, date-range presented data, individual company data, market segment data, entire market data, geographical region data, country data, revenue data, units data, and user-defined data.

2. Background of the Invention

The current state of knowledge is as follows. Market share data is often provided to subscribers as paper documents that contain charts and tables according the research data found and presented by a research services vendor. Analysts are therefore often unable to modify such reports after the fact, ask follow on questions, ask for data to be presented in various customized ways, or request the same report but with updated data, unless they place a new order with the research provider.

Accordingly, there is a long-felt need to address these and other issues regarding the generation and provision of real-time, interactive access to research databases.

### BRIEF SUMMARY OF THE INVENTION

In a preferred embodiment, there is provided a method for providing quantitative market share data over a computer network from a vendor to a subscriber, comprising the steps of: (i) Providing a subscriber with secure access to a custom market share research environment, said custom market share research environment comprising an interactive graphical user interface for viewing quantitative market share data stored in a database, wherein said interactive graphical user interface comprises an access feature for accessing said data and a control feature for generating one or more customized views of said data, wherein said one or more customized views of said data is based upon one or more parameters selected by said subscriber, said parameters comprising quarterly data, yearly data, date-range presented data, individual company data, market segment data, entire market data, geographical region data, country data, revenue data, units data, and user-defined data; and, (ii) Generating and publishing a dynamically interactive report based on said parameters of market share data in real time, wherein said subscriber obtains the report during a single access session.

In additional non-limiting preferred embodiments, the method further comprises additional features, including without limitation wherein the method is a web-based application, and/or wherein the graphical user interface provides an e-mail feature for generating and publishing a report to an e-mail address, and wherein the report to an e-mail address comprises interactive features for dynamically interacting with said report, or wherein said report is published as a dynamically interactive graph to provide trend analysis, and/or wherein said report is saved to a subscriber profile and is re-accessible during a later access session, and/or wherein said user-defined data is a customized market definition selected by the subscriber, and/or various combinations of the features described herein.

In another preferred embodiment of the present inventive subject matter, there is provided a system for providing quantitative market share data over a computer network from a vendor to a subscriber, the system comprising a server comprising a computer readable medium comprising program instructions executable by the server to: (i) Provide an interface configured to provide a subscriber with secure access to a custom market share research environment, said custom market share research environment comprising an interactive graphical user interface for viewing quantitative market share data stored in a database on the server, wherein said interactive graphical user interface comprises an access feature for accessing said data and a control feature for generating one or more customized views of said data, wherein said one or more customized views of said data is based upon one or more parameters selected by said subscriber, said parameters comprising quarterly data, yearly data, date-range presented data, individual company data, market segment data, entire market data, geographical region data, country data, revenue data, units data, and user-defined data; and, (ii) Generate and publish a dynamically interactive report based on said parameters of market share data in real time, wherein said subscriber obtains the report during a single access session.

In additional non-limiting preferred embodiments, the system further comprises additional features, including without limitation wherein the program instructions are further executable by the server to provide the interface and report generation as a web-based application, and/or wherein the program instructions are further executable by the server to provide an e-mail feature for generating and publishing a report to an e-mail address as part of the graphical user interface, and wherein the report to an e-mail address comprises interactive features for dynamically interacting with said report, and/or wherein the program instructions are further executable by the server to provide the published report as a dynamically interactive graph to provide trend analysis, and/or wherein the program instructions are further executable by the server to provide the report saved to a subscriber profile and re-accessible during a later access session, and/or wherein the program instructions are further executable by the server to provide wherein said user-defined data is a customized market definition selected by the subscriber, and/or various combinations of the features described herein.

### BRIEF DESCRIPTION OF THE DRAWINGS

FIG. 1 is a screen shot of the iAnalysis Home Web page that displays information about the telecommunication and network industry. It presents the various service categories iAnalysis offers.

FIG. 2 is a diagram and list that depicts a set of Web components/architecture.

FIG. 3 is a flowchart diagram that illustrates the log-in operational flow to the site that is used by registered user.

FIG. 4 is a flowchart diagram that illustrates how the tree works.

FIG. 5-A through 5-D show a flowchart diagram that illustrates how the site works. The diagram depicts six processes: (1) Services, (2) One-Click Research, (3) Create New Virtual Tree, (4) Trends, (5) One-Click Forecast, and (6) My Virtual Tree.

FIG. 6 is a flowchart diagram that illustrates the process One-Click Research.

FIG. 7 is a flowchart diagram that illustrates the process Create New Virtual Tree.

FIG. 8 is a flowchart diagram that illustrates the process Trends.

FIG. 9 is a flowchart diagram that illustrates the process One-Click Forecast.

FIG. 10-A through 10-D show a flowchart diagram that illustrates the process My Virtual Tree.

FIG. 11—is a screen shot of a web page of one embodiment of the invention and shows how a user/subscriber can adjust key parameters that underlie market share data is available using a point and click report generator.

FIG. 12—is a screen shot of a web page of one embodiment of the invention and shows how reports may also be exported to an Excel® spreadsheet.

FIG. 13(a), 13(b) show a screen shot of a web page of one embodiment of the invention and shows how various options are available for the type of chart or table that displays market share and forecast data

FIG. 14(a), 14(b) show a screen shot of a web page of one embodiment of the invention and shows how this embodiment, called Synergy Interactive Analysis® (SIA®), is able to dynamically query market share and forecast data for any region or country.

FIG. 15—is a screen shot of a web page of one embodiment of the invention and shows how the data may be chosen, or “cut” according to revenue, units, ports, or subscribers provides dynamic market intelligence in seconds, and not hours.

FIG. 16—is a screen shot of a web page of one embodiment of the invention and shows how a user/subscriber can select data subparts to identify market trends.

FIG. 17—is a screen shot of a web page of one embodiment of the invention and shows how charts and graphs may be e-mailed and the chart or graph comes fully enabled with the same interactive features possible from the server. The charts or graphs may also be saved as jpeg images for convenient presentation.

FIG. 18(a), 18(b) is a screen shot of a web page of one embodiment of the invention and shows how one feature, here called One-Click Research®, available within the charts or graphs provides for interaction with the graphs.

FIG. 19(a), 19(b), 19(c) shows a screen shot of a web page of one embodiment of the invention and shows how customized market segmentations of data may be built and saved for access and re-access.

### DETAILED DESCRIPTION OF THE INVENTION

### Definitions

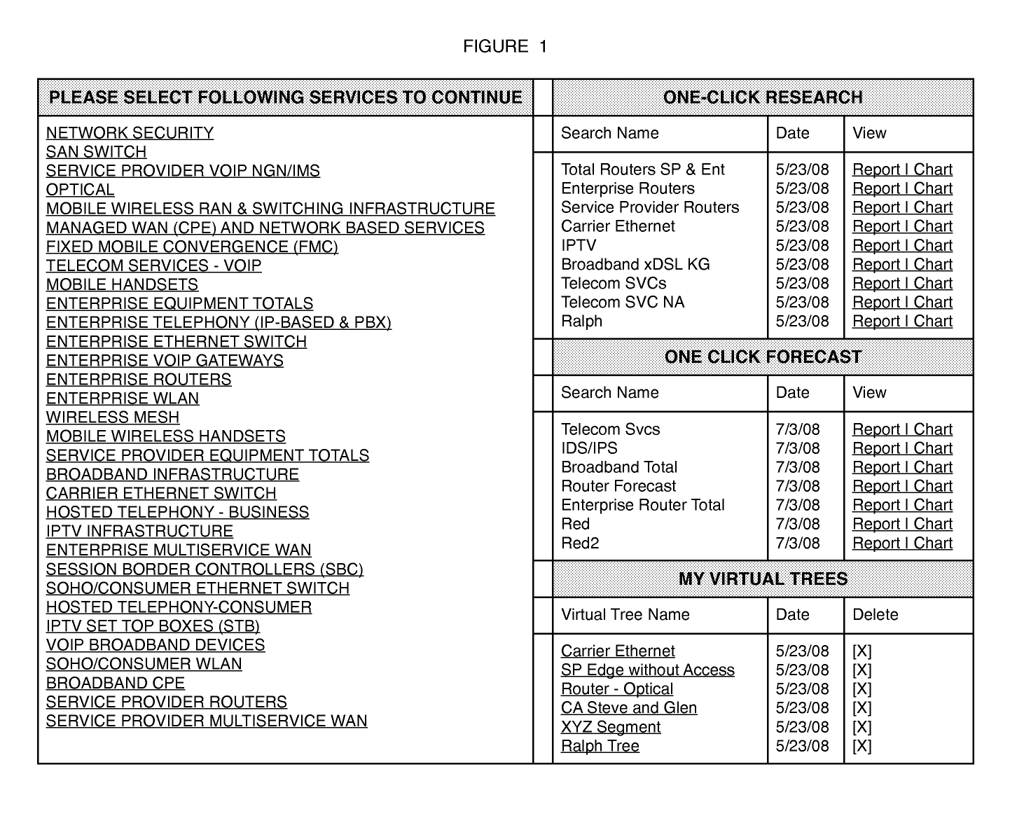

With reference to figure FIG. 1, a screen shot of the iAnalysis® Home Web page, a network search system in accordance with the present invention includes a client computer operated by a user desiring to search data, a merchant computer, which is operated by Synergy Research Group willing to sell data via a subscription to the site to the client. The screenshot displays information about the telecommunication and network industry. It presents the various services categories iAnalysis® offers (on the left column) and unique features of the present invention, such as One-Click Research®, One-Click Forecast®, My Virtual Tree®, Create New Virtual Tree and Trends.

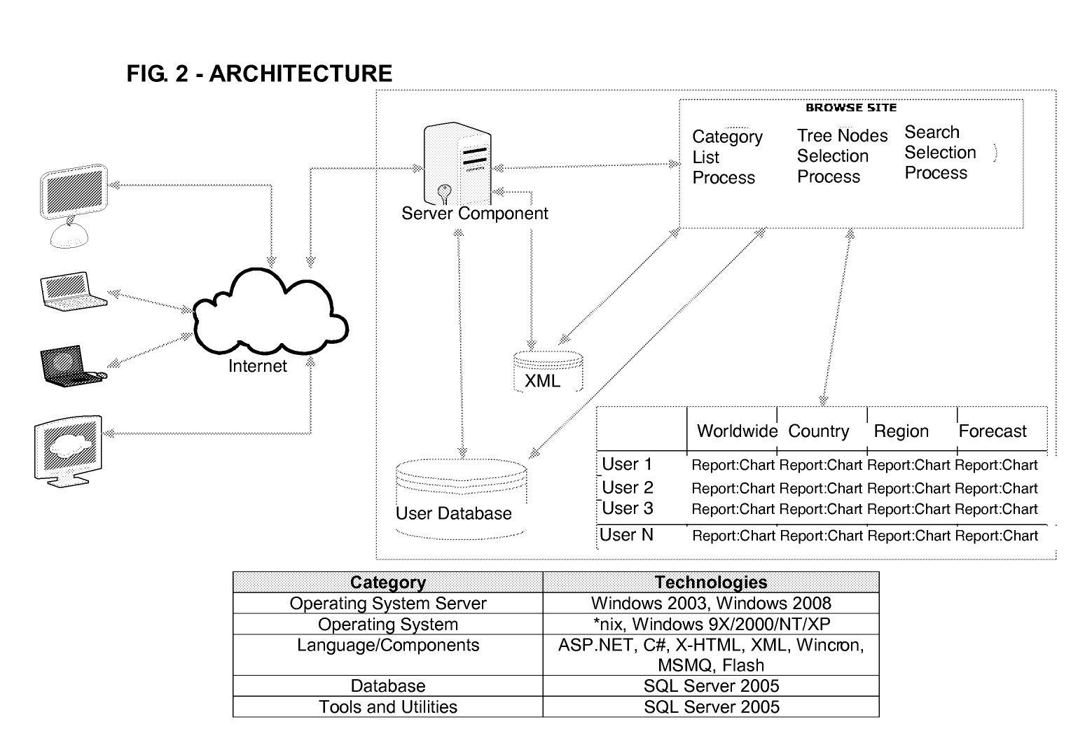

With reference to FIG. 2, a diagram and list that depicts a set of Web components/architecture and how those components operate via client computer, iAnalysis® server, database and the Internet to provide the client with the data requested.

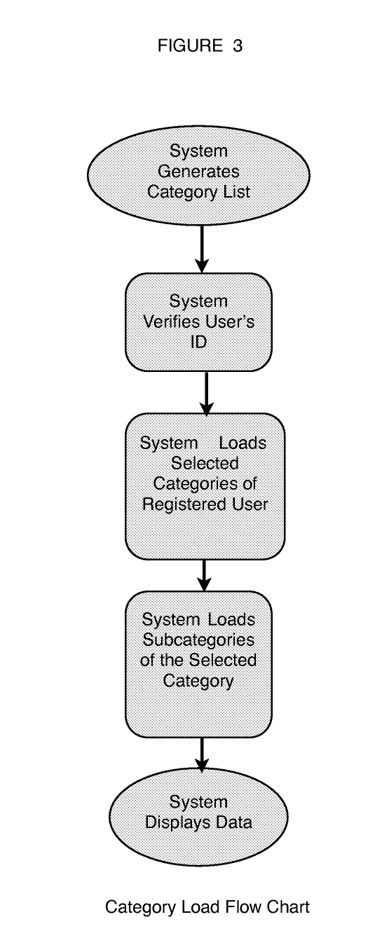

With reference to FIG. 3, a flowchart diagram that illustrates the log-in operational flow to the site that is used by the registered user; the system does not permit accessibility of the site by nonregistered users. After the system authenticates the user, the user is permitted to access the site and use its functionality according to user's preference. Only the list of services that user selected the time of registration display. Once the user logs in with a user I.D., the system generates and loads the client's category and subcategories of the selected category. The system generates and displays the client's data.

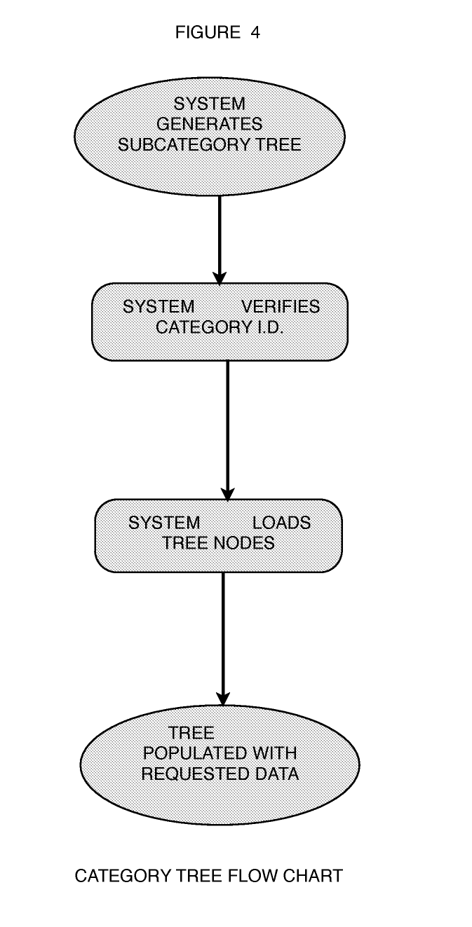

With reference to FIG. 4, a flowchart diagram that illustrates how the tree works, once the system verifies the user's I.D. and gives the user permission to construct the tree utilizing the subcategories for the registered category, the user generates a subcategory tree. The system loads the tree nodes with the user's subcategory data.

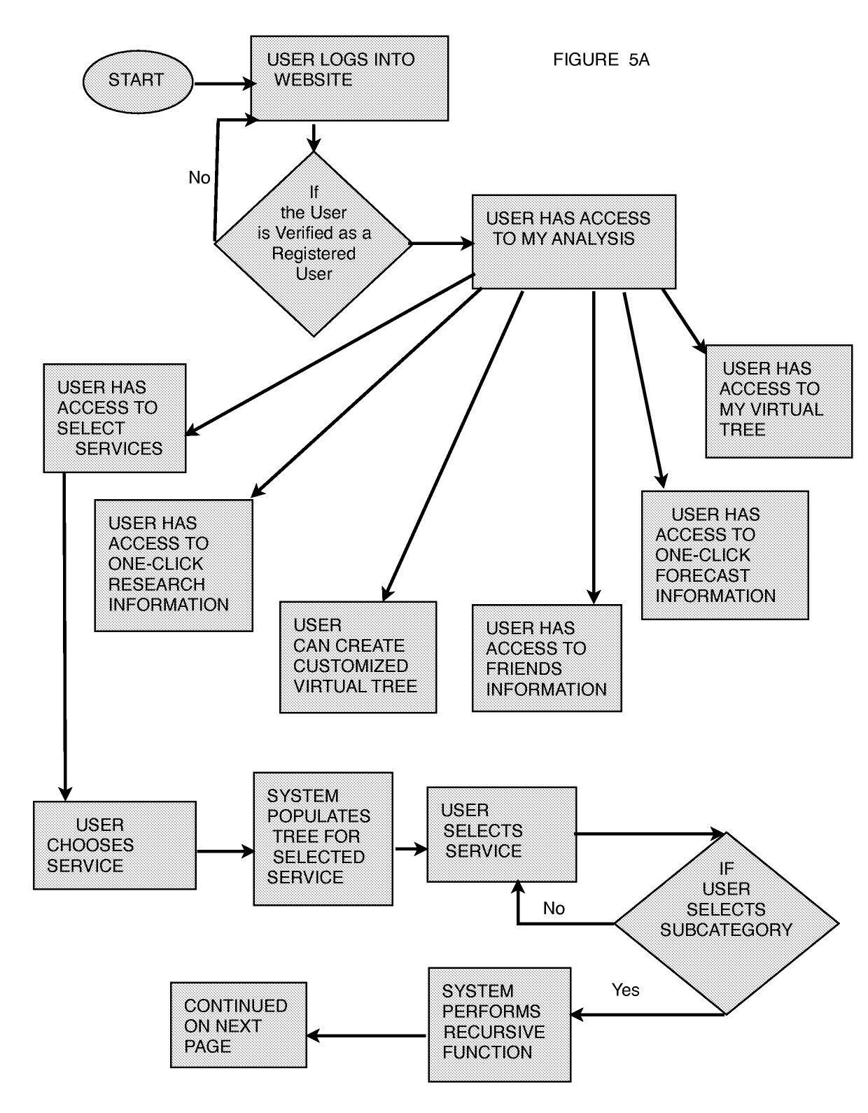

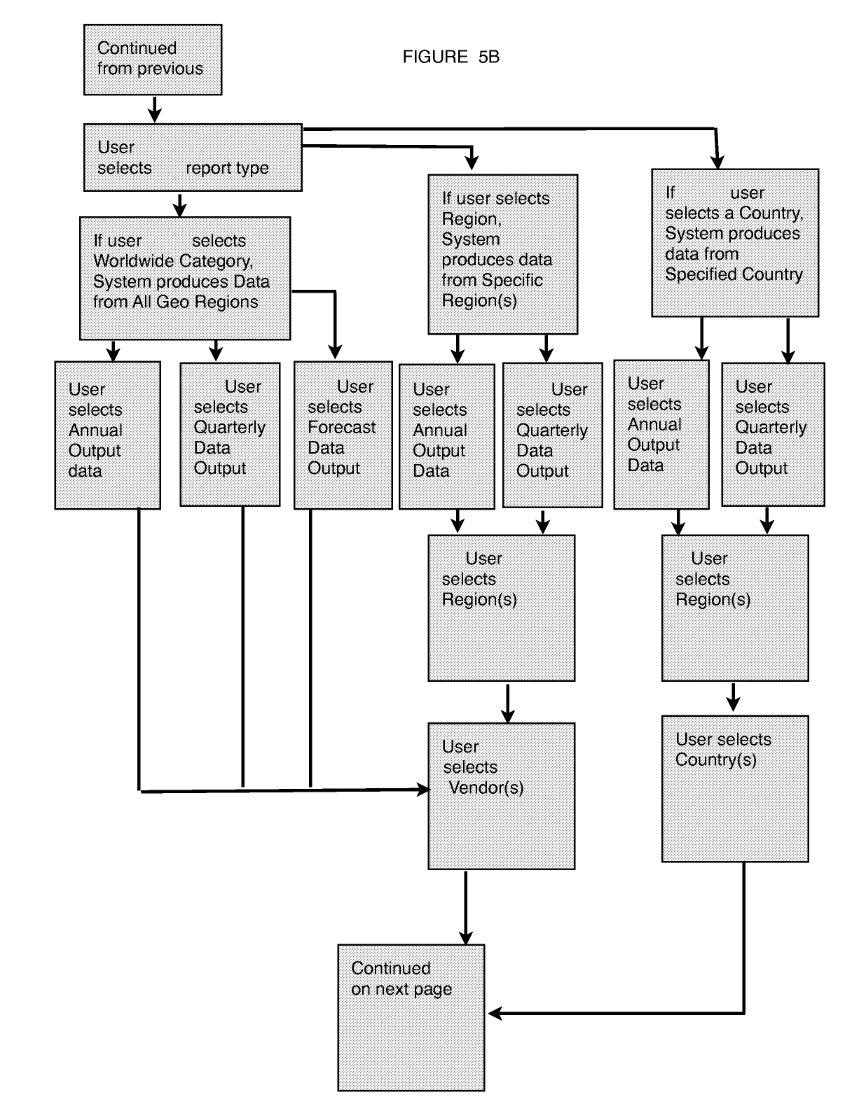

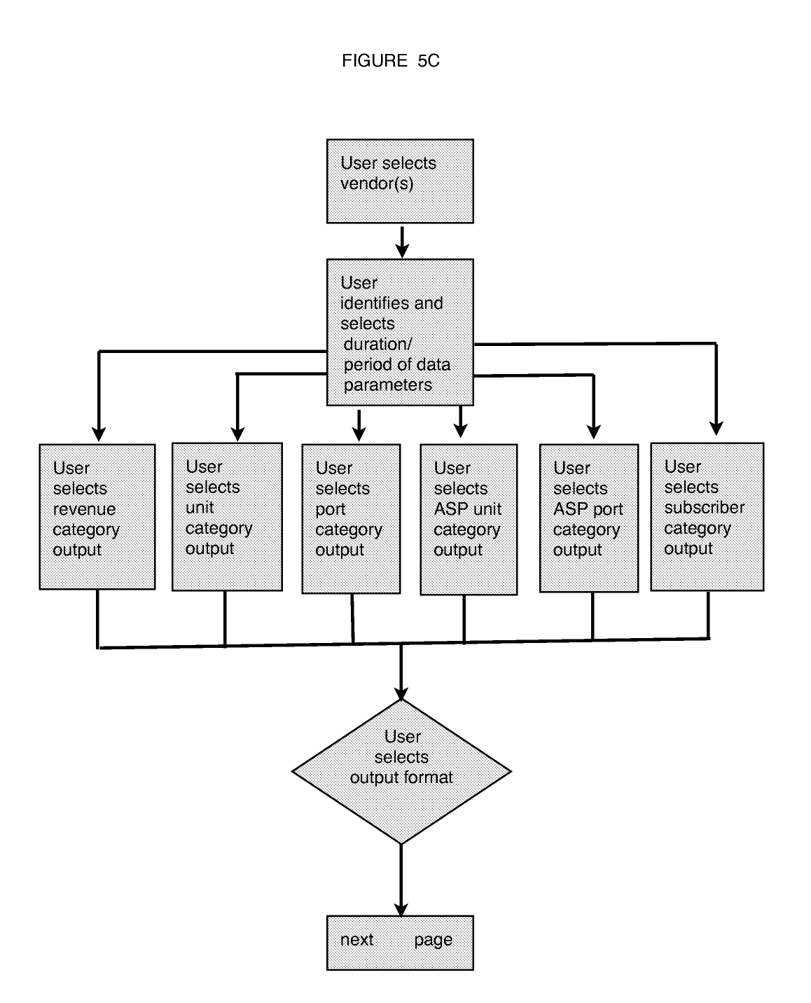

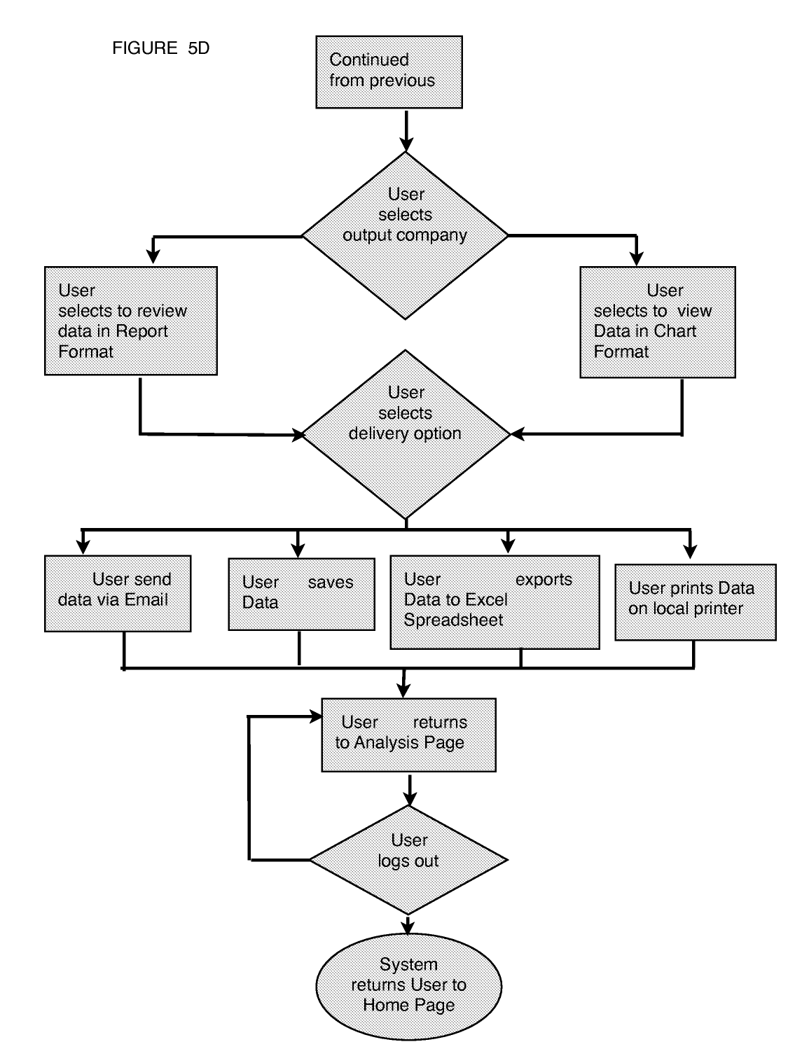

With reference to FIG. 5.A (5.A through 5.D), a flowchart diagram that illustrates how the site works, the user selects one or all of the following: Services, One-Click Research®, Create New Virtual Tree, Trends, One-Click Forecast®, and My Virtual Tree®. FIG. 5.A diagram shows the first process Services. The user logs into the system. Once the system authenticates the user's I.D. the user is logged in to My iAnalysis®. From My iAnalysis® the user selects a process category and subcategory. The system populates a tree of the selected category/subcategory data, and the system utilizes the recursive function to populate the tree.

With reference to FIG. 5.B, a flowchart diagram that illustrates the continuation of the process Services, after selecting the node of the tree, the user selects a report type from a list from the following categories: worldwide, country, and region. The user can refine the report type to select data annually, quarterly or forecast. The user next selects from a list the vendors for which to display the data.

With reference to FIG. 5.C, a flowchart diagram that illustrates the continuation of the process Services, after selecting the vendor, the user selects the time period parameters for the data. The user selects the item type from the following categories: revenue, unit, port, ASP unit, ASP port, and subscriber.

With reference to FIG. 5.D, a flowchart diagram that illustrates the continuation of the process Services, after selecting the search criteria, the user selects either to view data in report format or in chart format. The user selects how to distribute the chart or report. The user can (1) send the chart or report via e-mail; (2) save the chart or report; (3) export the data to an Excel® spreadsheet; or (4) print the generated report or chart from a local printer. The system next directs the user back to My iAnalysis® page. The user can either choose to initiate another process or to log out and return to the Home page.

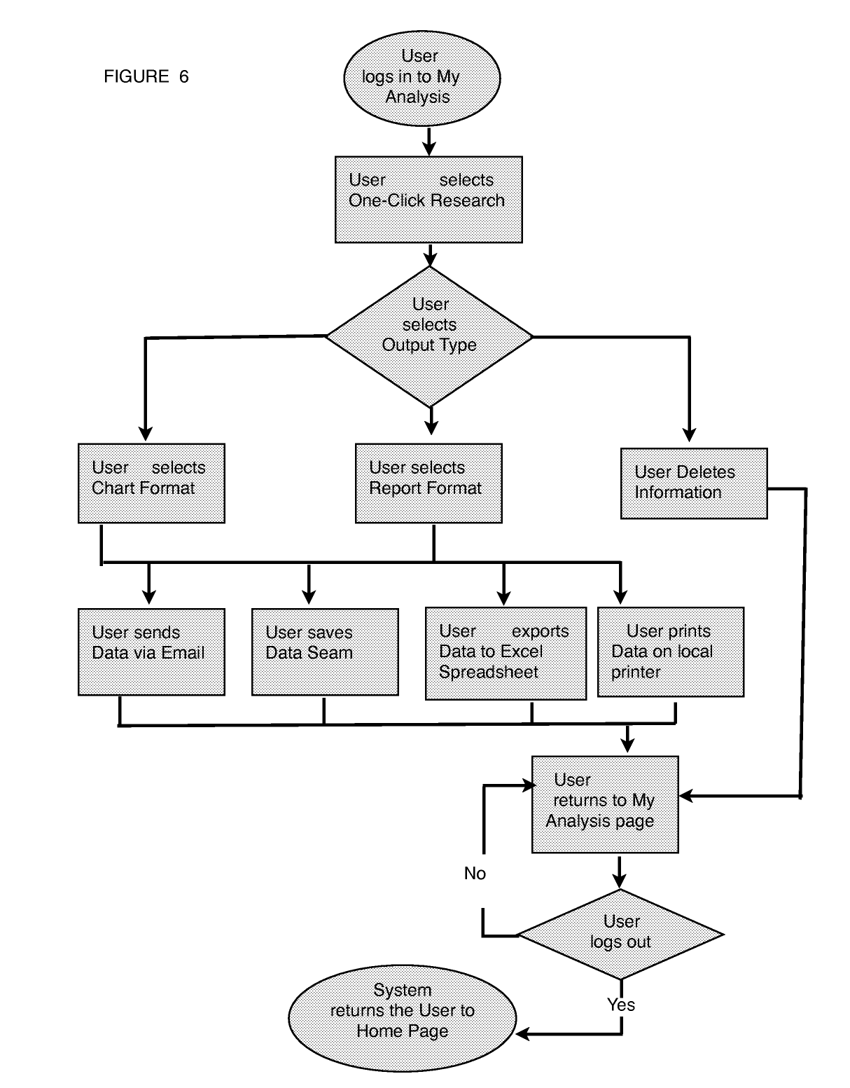

With reference to FIG. 6, a flowchart diagram that illustrates the process One-Click Research®, the user views the report or chart (if saved) or can delete the report or chart. The user then selects how to distribute the chart or report. The user can either (1) send the report or chart via e-mail; (2) save the report or chart using another name; (3) export the report or chart to an Excel spreadsheet; or (4) print the report or chart from a local printer. Upon completion of the function the system directs the user back to My iAnalysis® page. The user can either choose to initiate another process or to log out and return to the Home page.

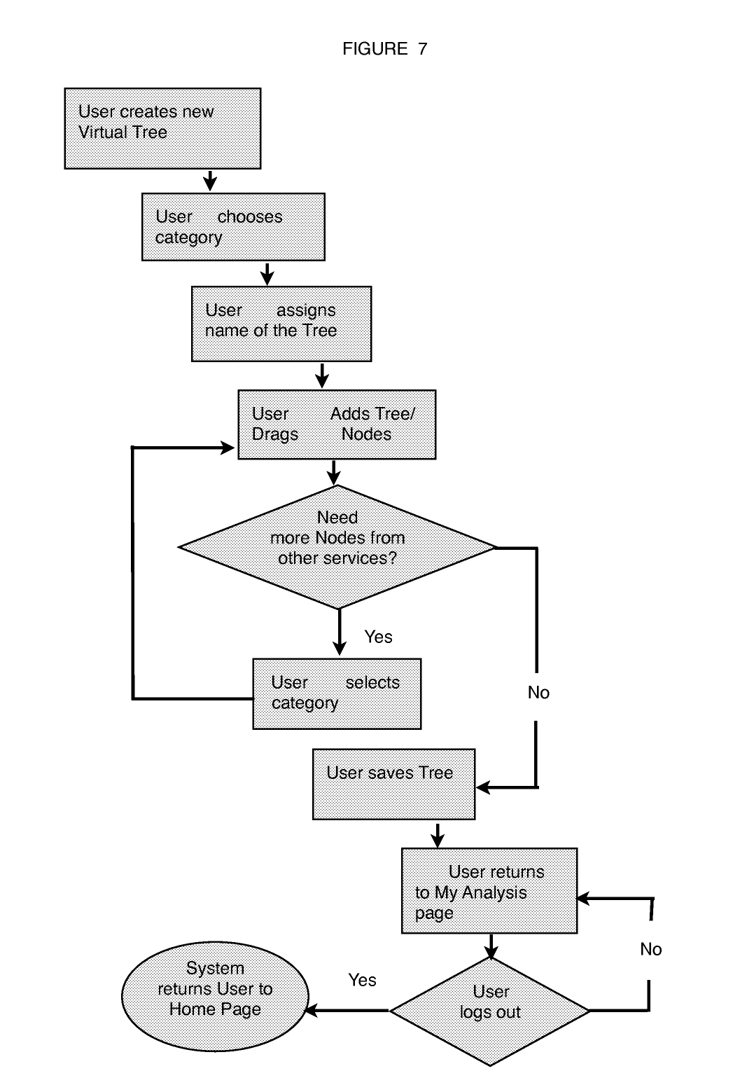

With reference to FIG. 7, a flowchart diagram that illustrates the process Create New Virtual Tree, the user constructs a customized tree by selecting Create New Virtual Tree and selecting criteria from different categories to populate the tree. The user selects a category and assigns a name to the tree. The user then selects nodes and drags them to the tree. Once the virtual tree is created and customized, the user adds services from the virtual tree. The user saves the tree. The system directs the user back to My iAnalysis® page. The user can either choose to initiate another process or to log out and return to the Home page.

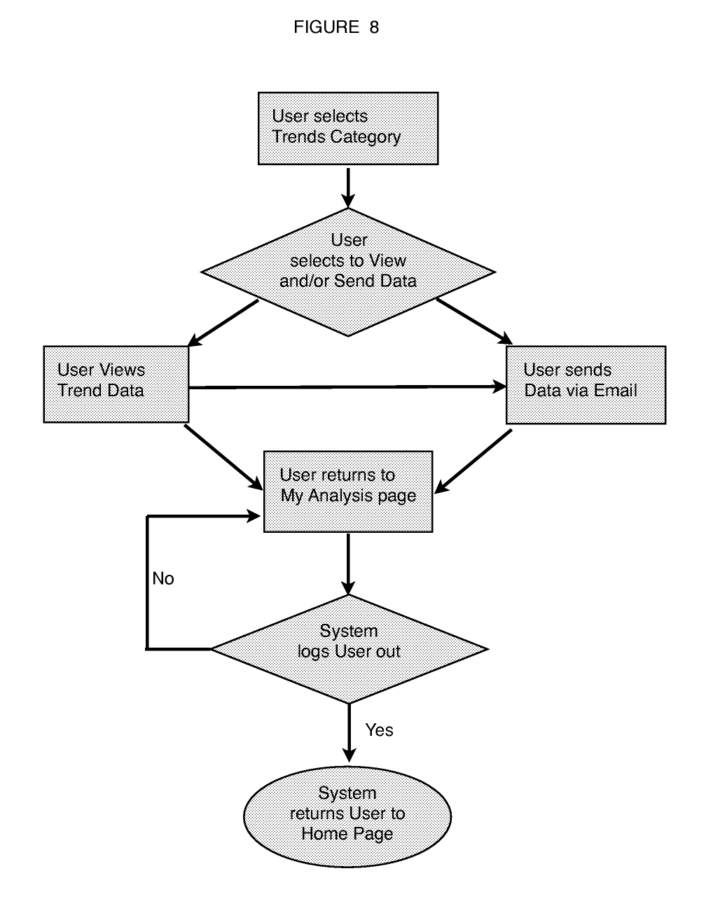

With reference to FIG. 8, a flowchart diagram that illustrates the process Trends, the user selects Trends to view telecommunication industry data. The user then can e-mail the data set. The system directs the user back to My iAnalysis® page. The user can either choose to initiate another process or to log out and return to the Home page.

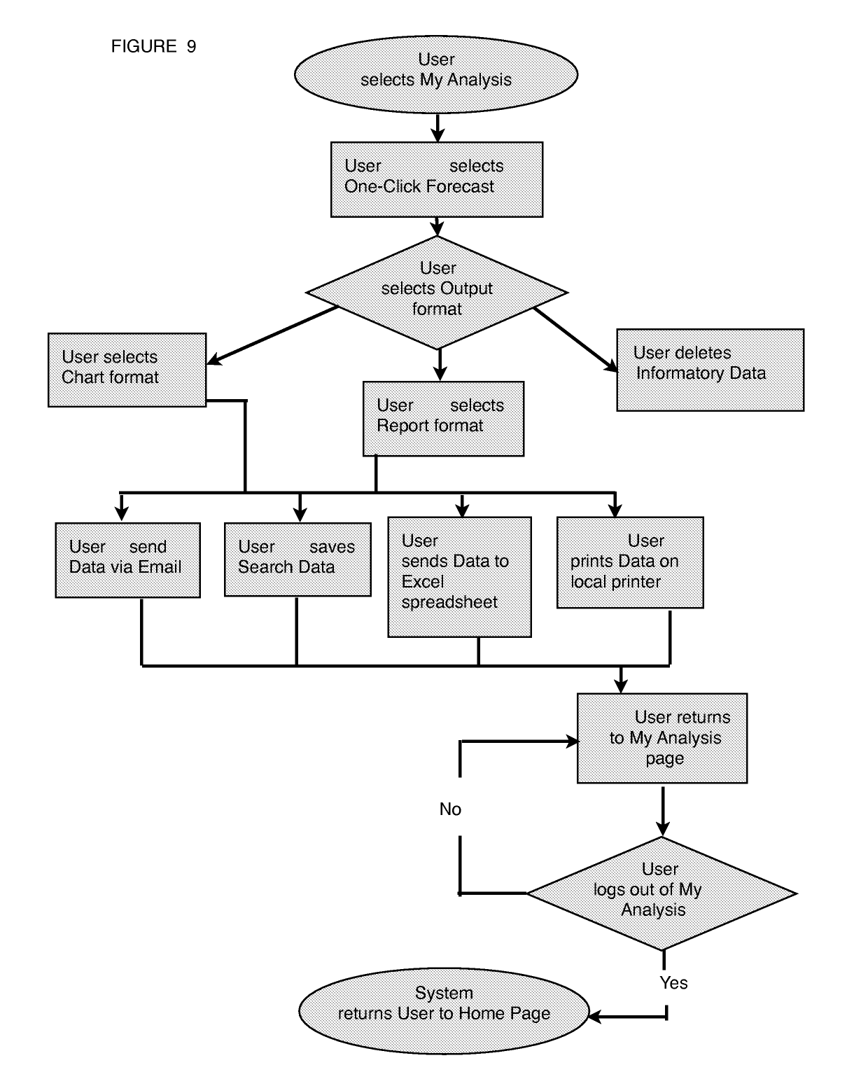

With reference to FIG. 9, a flowchart diagram that illustrates the process One-Click Forecast®, the user selects One-Click Forecast® and views the saved reports or charts of the forecast or deletes the reports or charts. The user can (1) send the report or chart via e-mail; (2) save the report or chart with another name; (3) export the report or chart data to an Excel® spreadsheet; or (4) print the report or chart from a local computer. Upon completion the system directs the user to My iAnalysis® page. From My iAnalysis® page the user can either initiate another process or log out and return to the Home page.

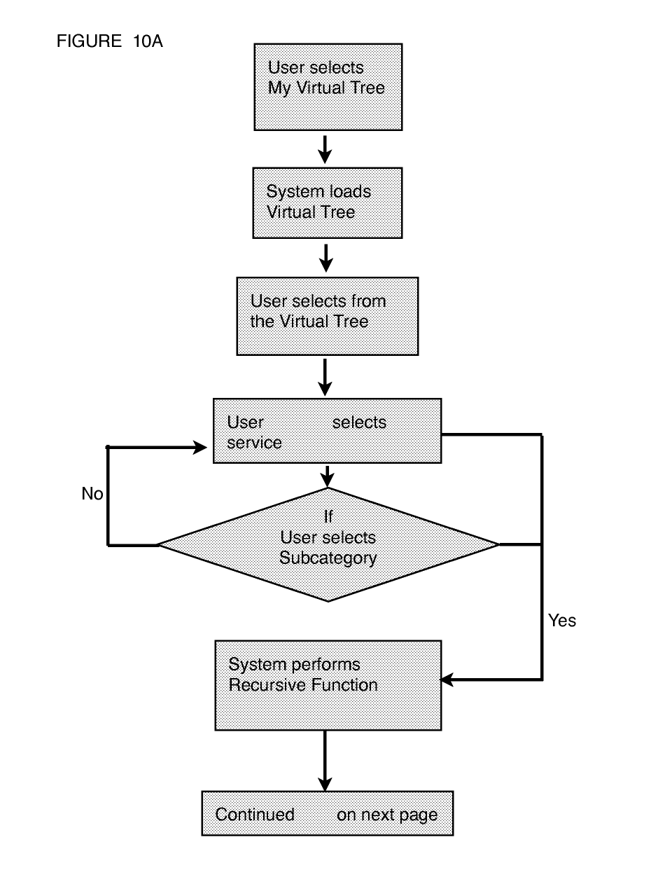

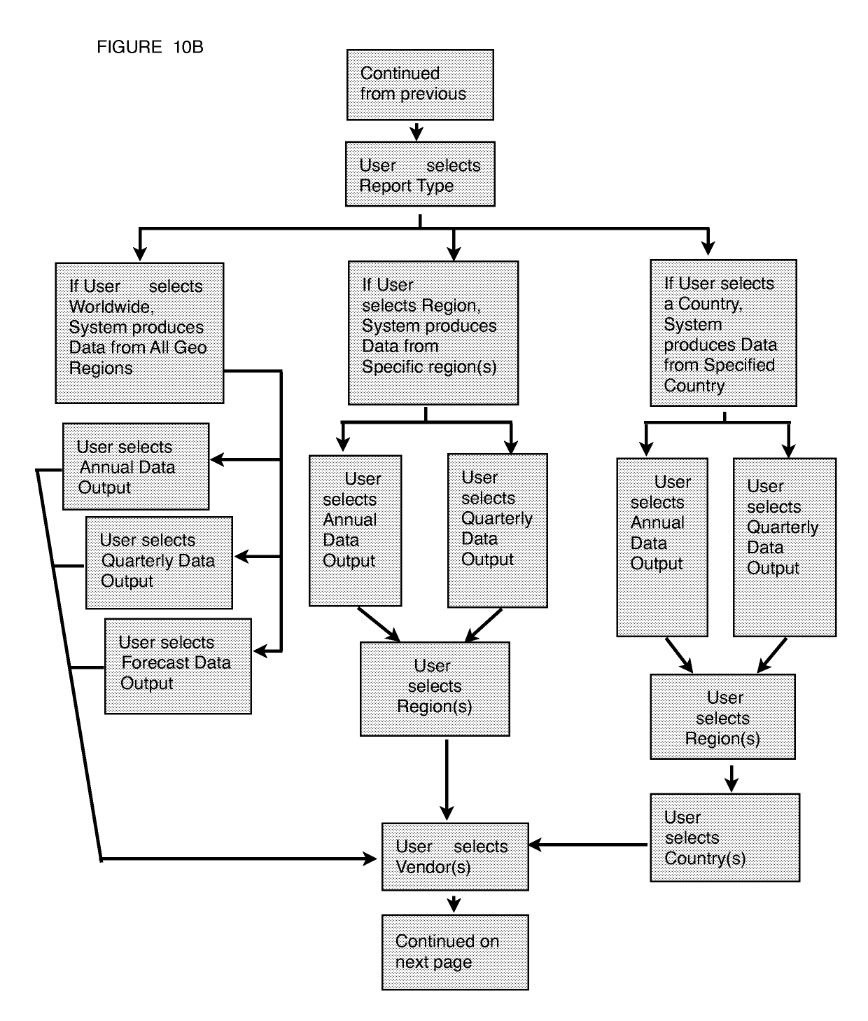

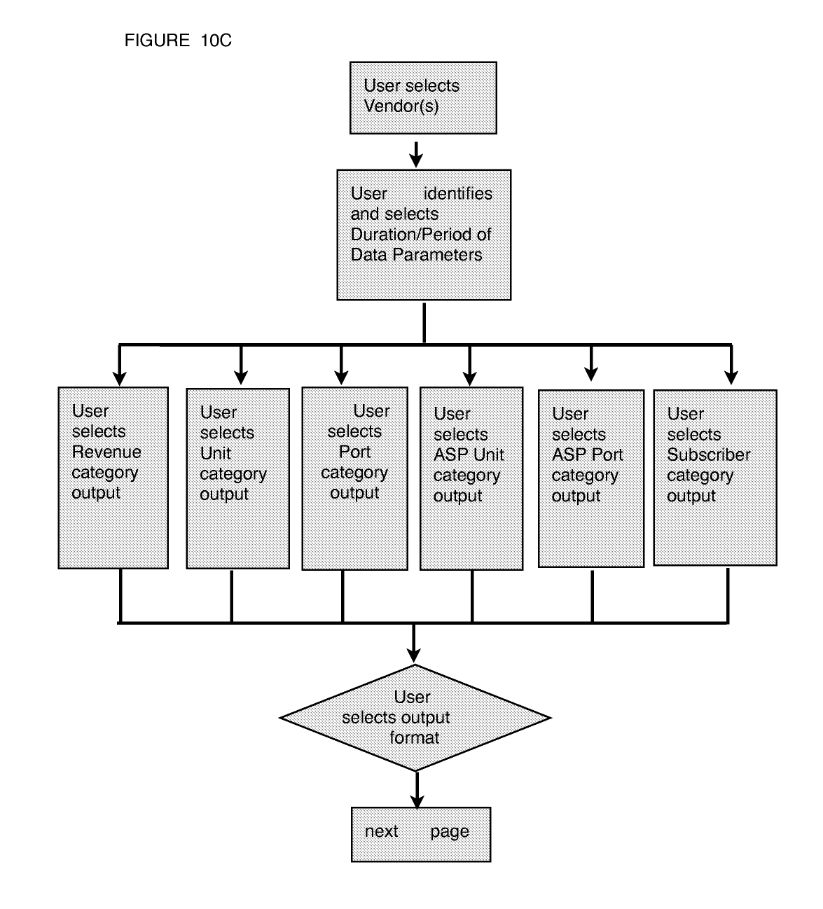

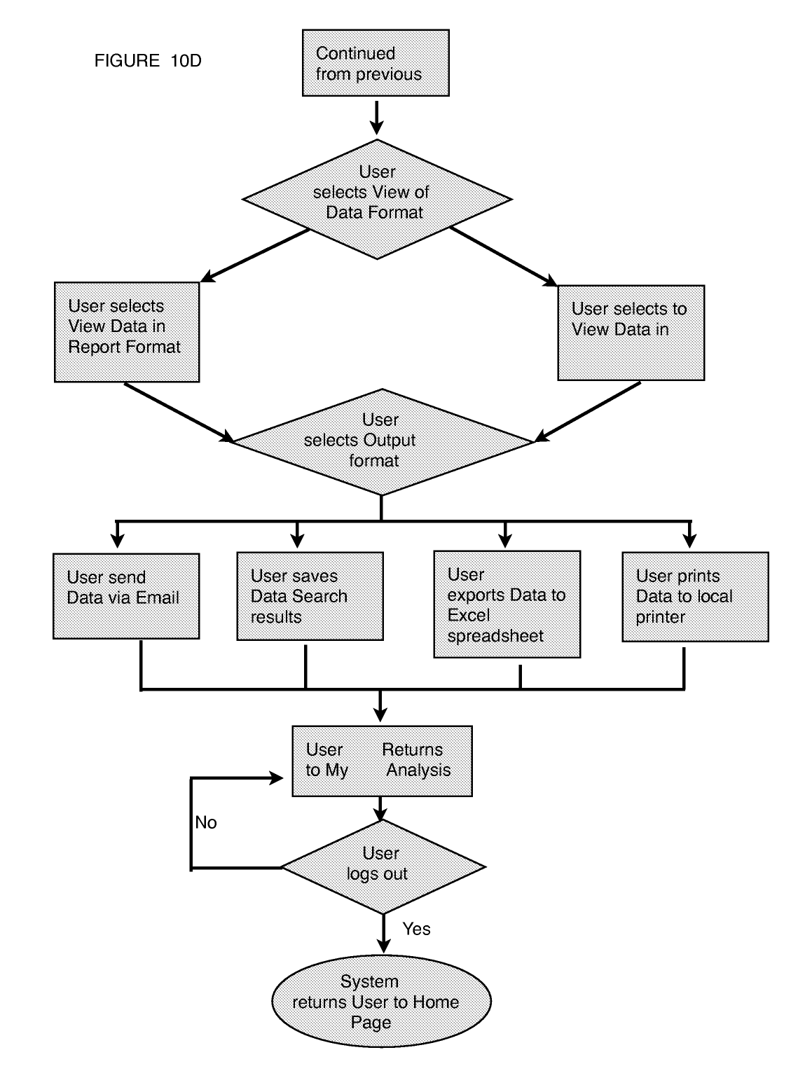

With reference to FIG. 10A through 10D, is a flowchart diagram that illustrates the process My Virtual Tree®, the user loads the data to the virtual tree. The user selects the services from the virtual tree. The user then selects subcategories. After the system performs the recursive function, the user selects a report type from a list from the following categories: worldwide, country, and region. The user can refine the report type to select data annually, quarterly or forecast. The user next selects from a list of vendors for which to display the data. After selecting the vendor, the user selects the time period parameters for the data. The user selects the item type from the following categories: revenue, unit, port, ASP unit, ASP port, and subscriber. After selecting the search criteria, the user selects either to view data in report format or in chart format. The user selects how to distribute the chart or report. The user can (1) send the chart or report via e-mail; (2) save the chart or report; (3) export the data to an Excel spreadsheet; or (4) print the generated report or chart from a local printer. The system next directs the user back to My iAnalysis® page. The user can either choose to initiate another process or to log out and return to the Home page.

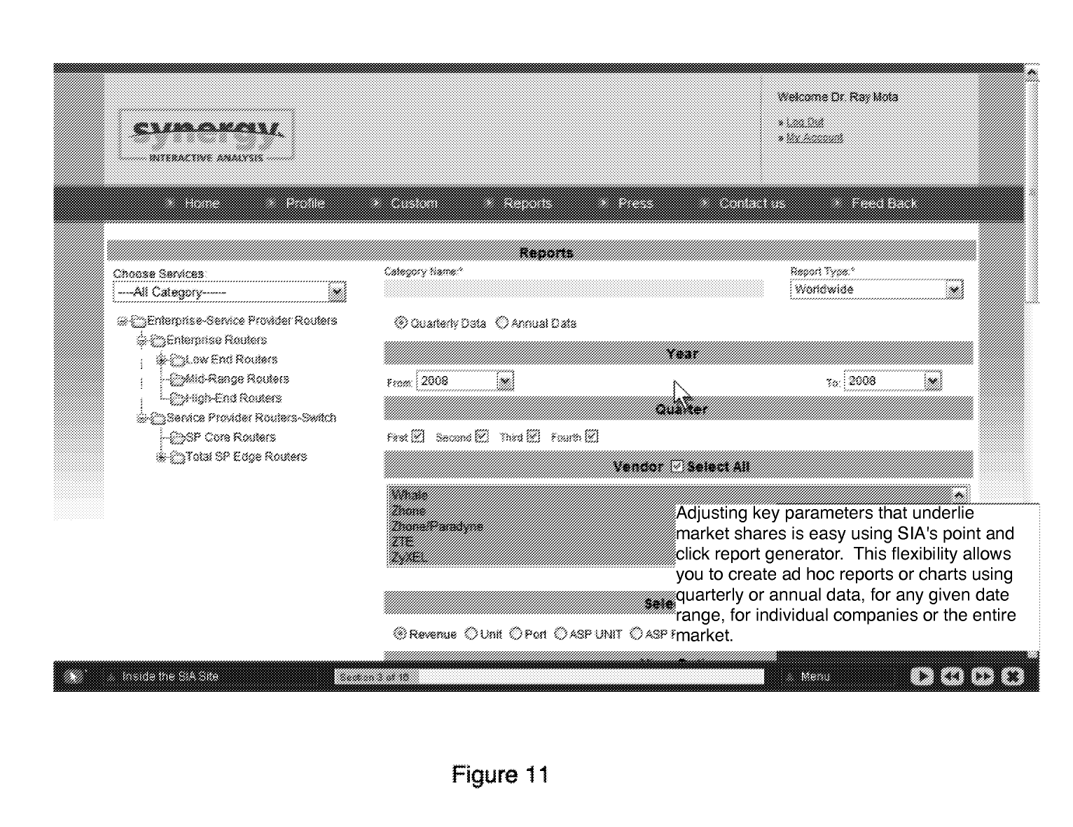

Referring now to FIGS. 11 through 19, a series of Web Pages are provided showing one exemplary embodiment of the present inventive subject matter. Also contemplated herein are variations which perform a similar or the same function, but which utilize different means.

In these figures, it is shown that SIA® allows creation of a custom research environment where the client controls and has direct access to research services, i.e. quantitative market data. As a web-based application, a client is provided with anytime access to market services not heretofore available.

Referring now to FIG. 11, a web page is shown how adjusting key parameters that underlie market share data is available using a point and click report generator. Reports can be charts having quarterly or yearly, for any given date range, for individual companies, for market segments, or for the entire selected market.

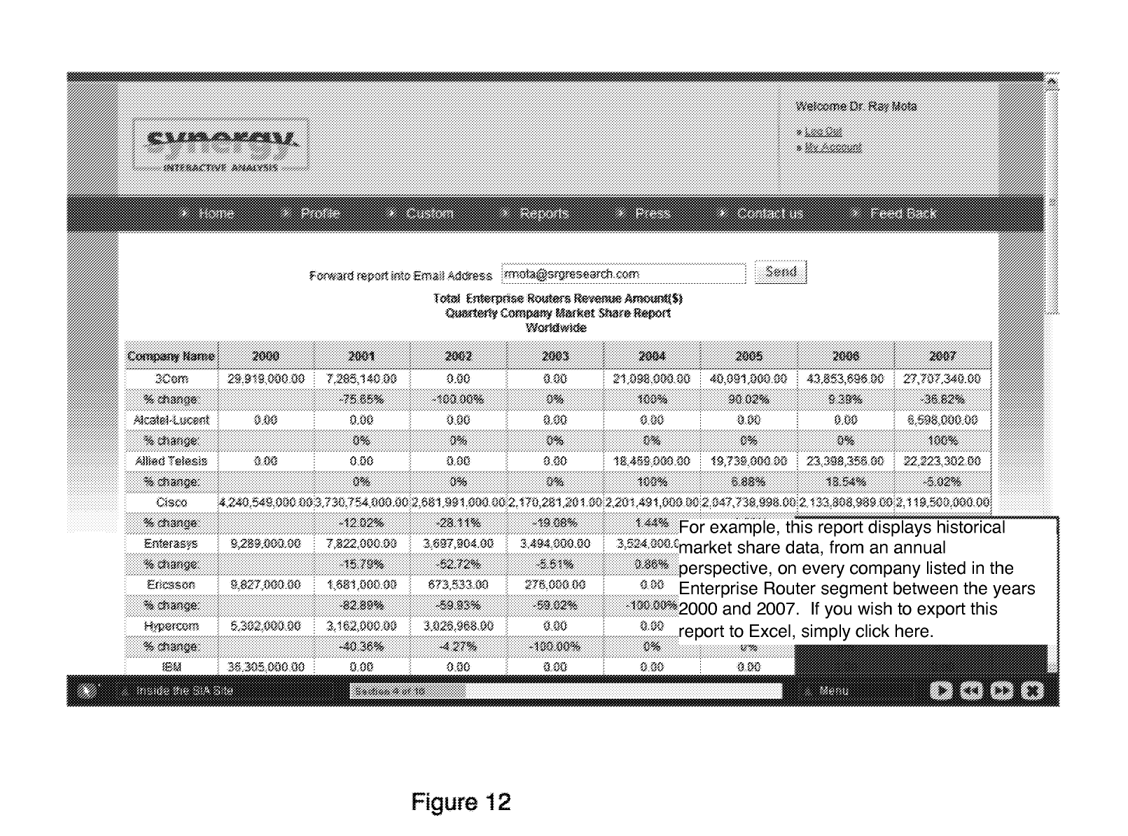

Referring now to FIG. 12, it shows how reports may also be exported to excel.

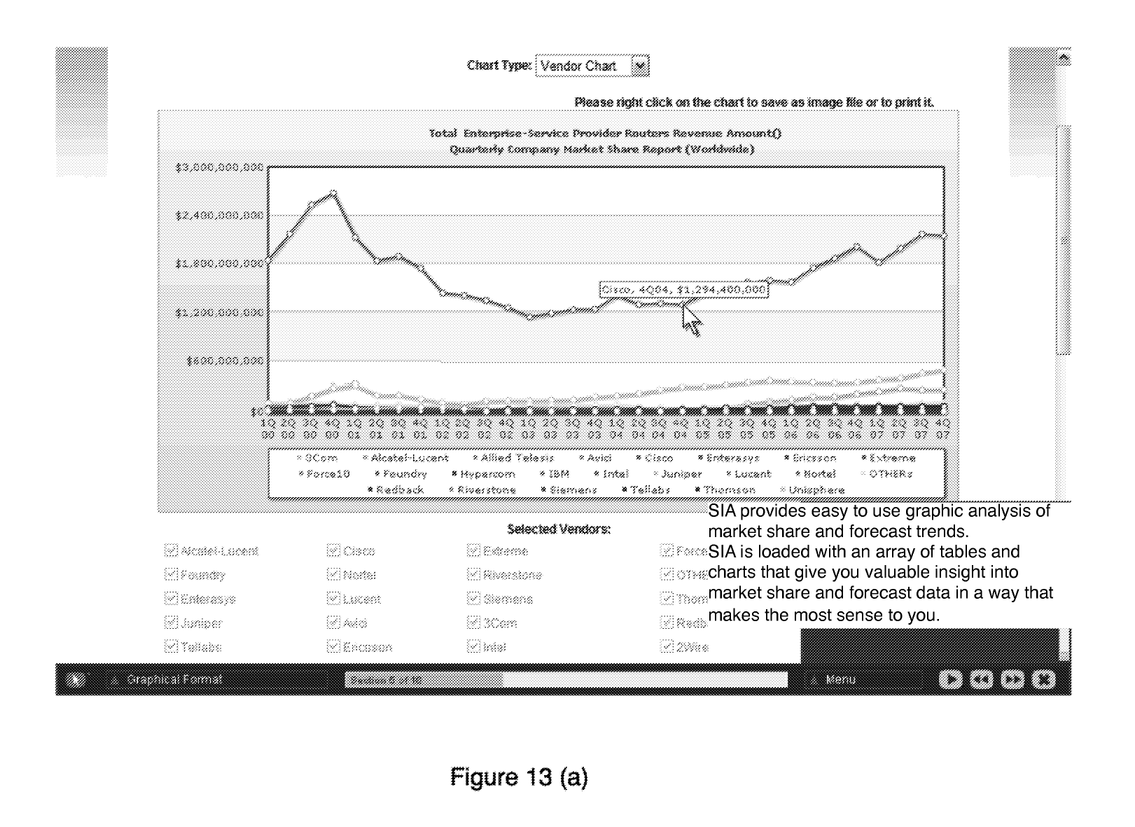

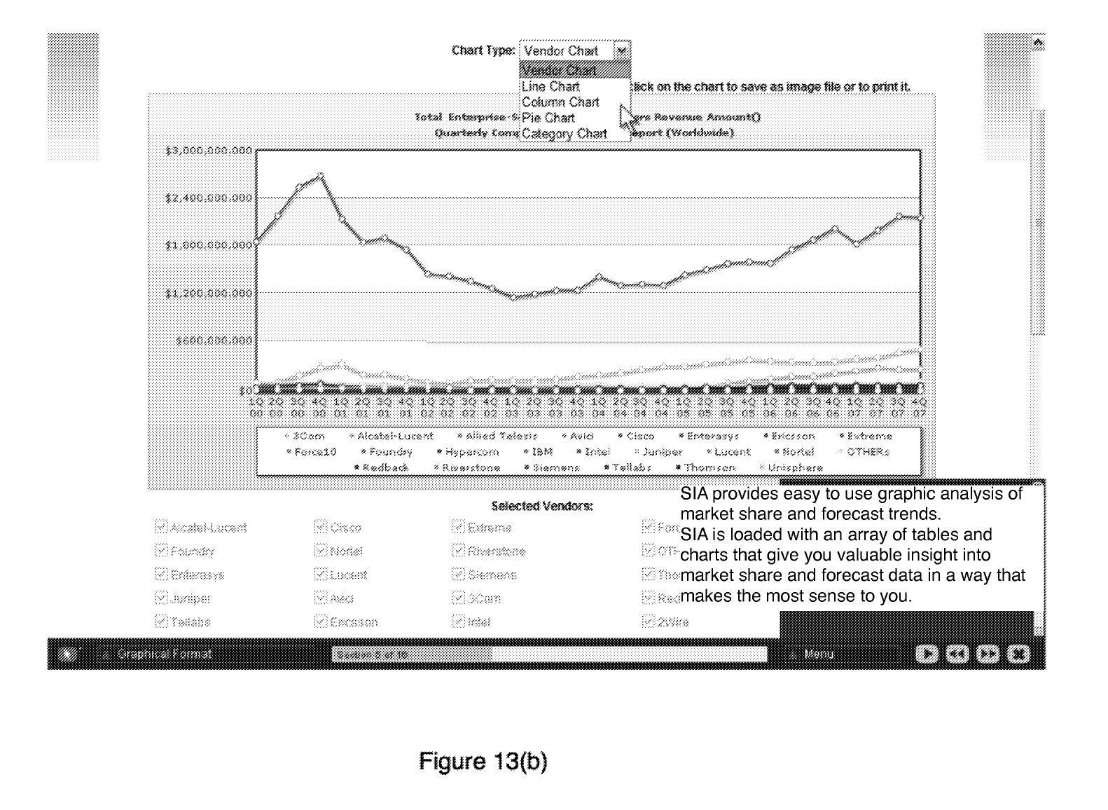

Referring to FIGS. 13(a) and 13(b) is shown how various options are available for the type of chart or table that displays market share and forecast data. Vender charts, line charts, column charts, pie charts, and category charts are non-limiting examples.

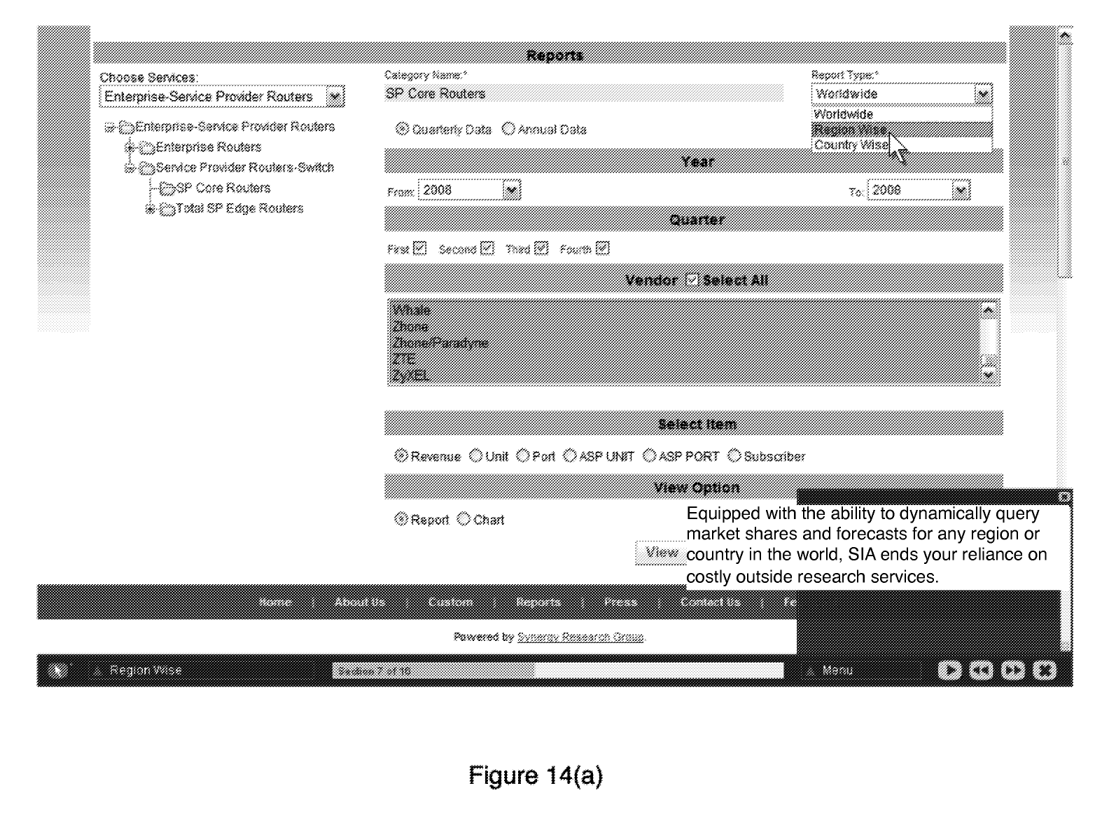

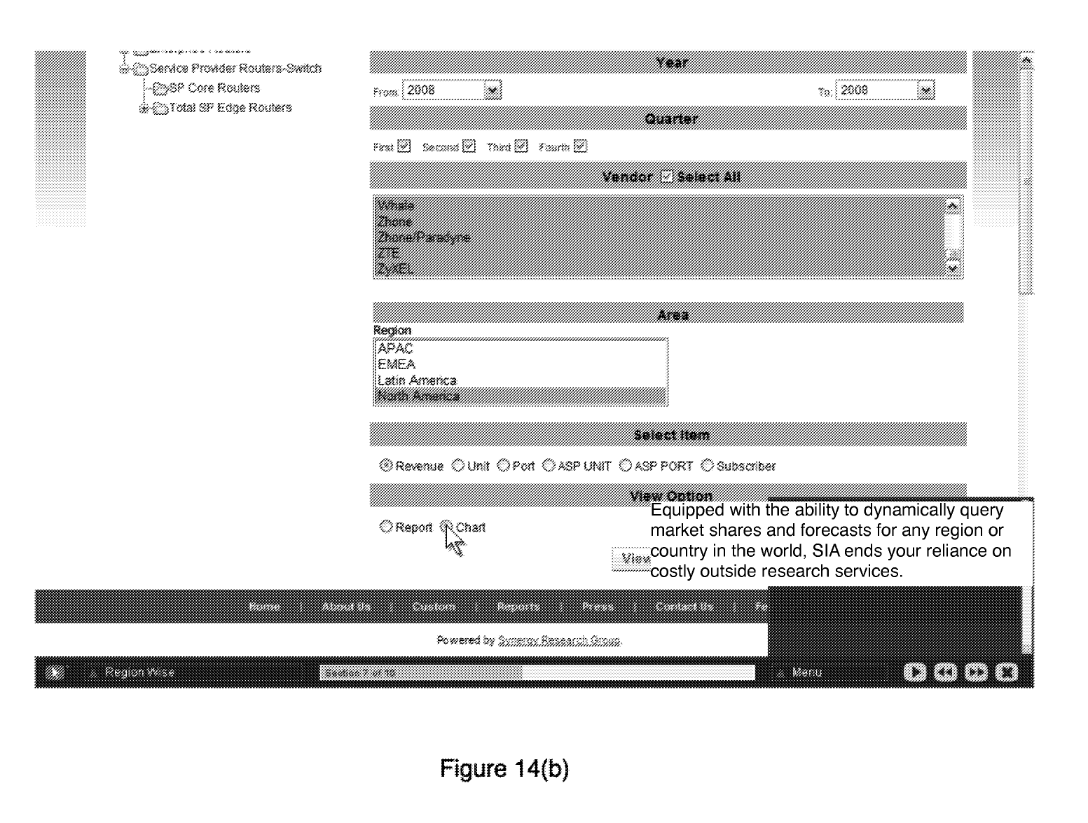

Referring to FIGS. 14(a) and 14(b), is shown how SIA® is able to dynamically query market share and forecast data for any region or country. For example, reports or charts may be generated for APAC, EMEA, Latin America, North America, and so forth.

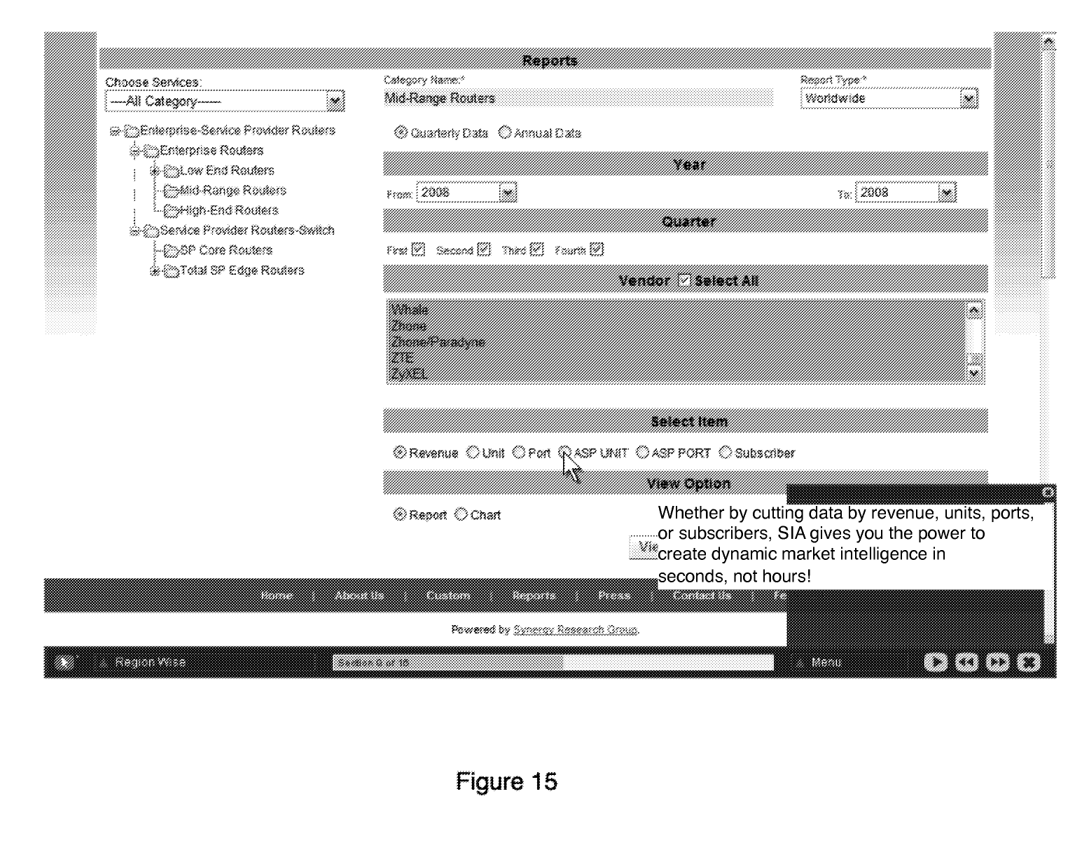

Referring to FIG. 15, is shown how cutting data by revenue, units, ports, or subscribers provides dynamic market intelligence in seconds, and not hours.

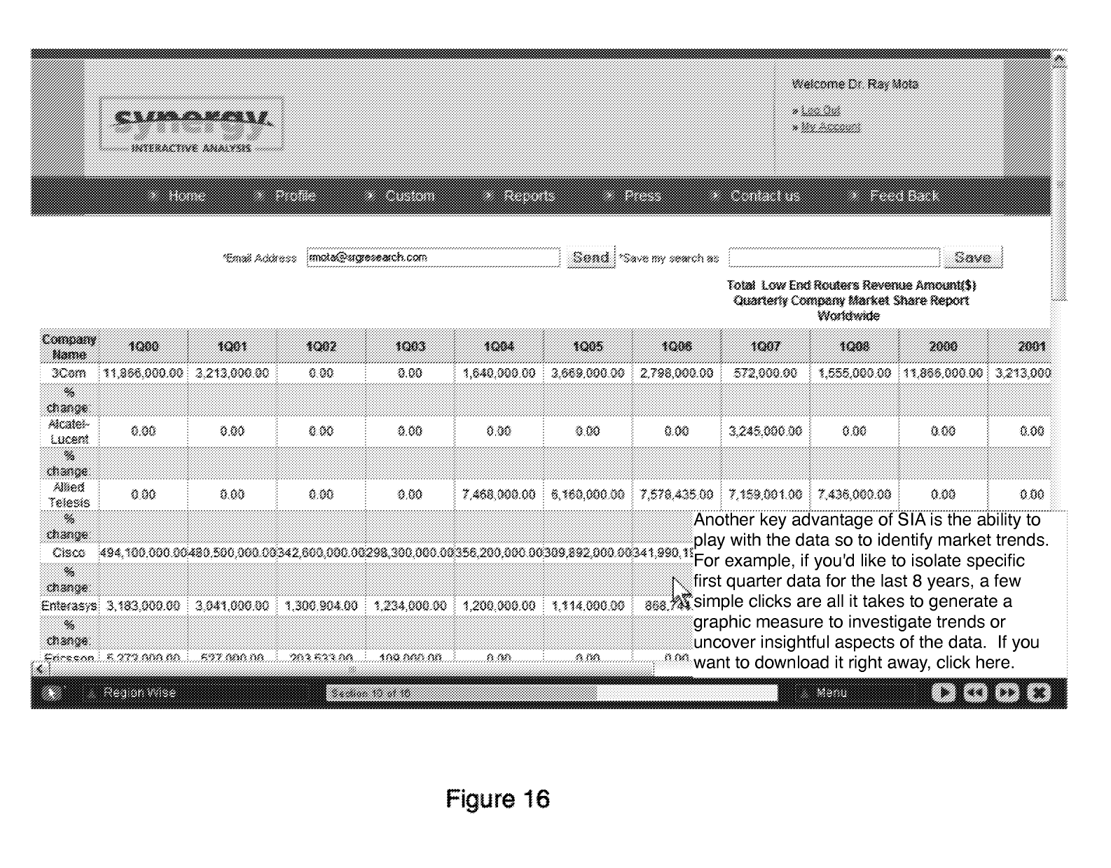

Referring to FIG. 16, is shown how another feature is the ability to select data subparts to identify market trends. For example, it is possible to isolate first quarter data over the last 8 years within a given market.

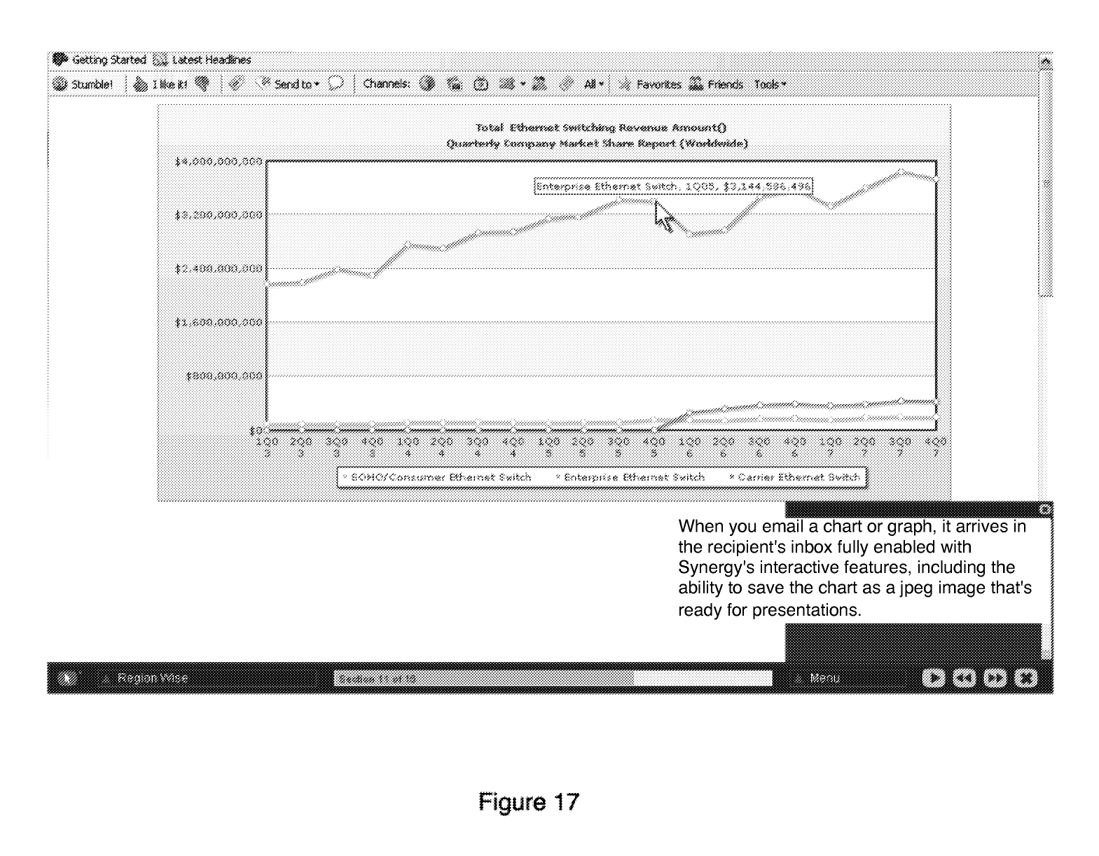

Referring to FIG. 17, is shown how charts and graphs may be e-mailed and the chart or graph comes fully enabled with the same interactive features possible from the server. The charts or graphs may also be saved as jpeg images for convenient presentation.

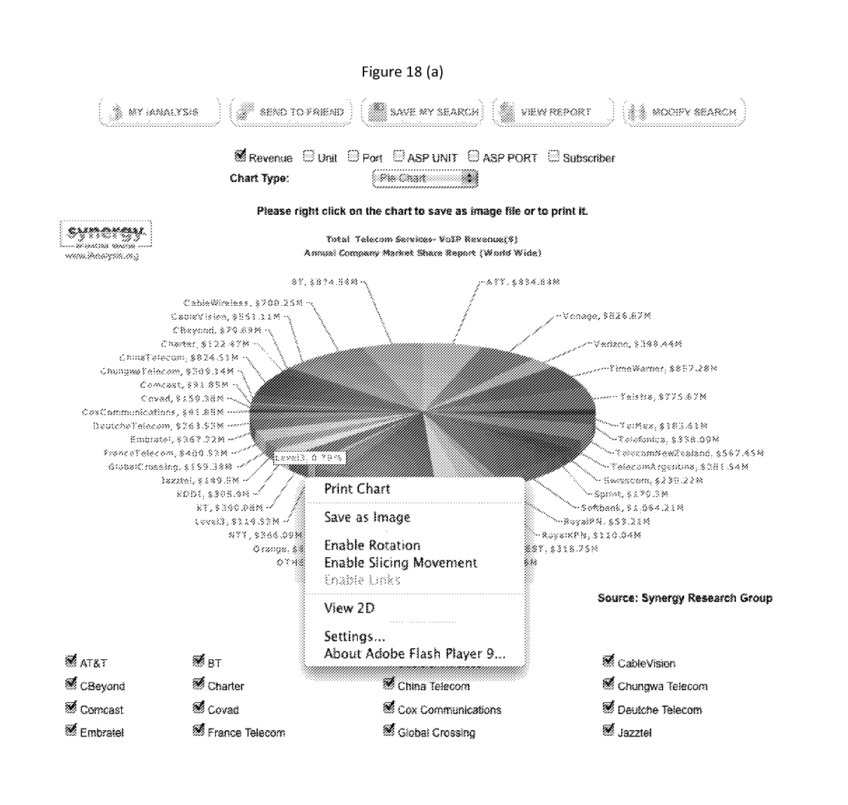

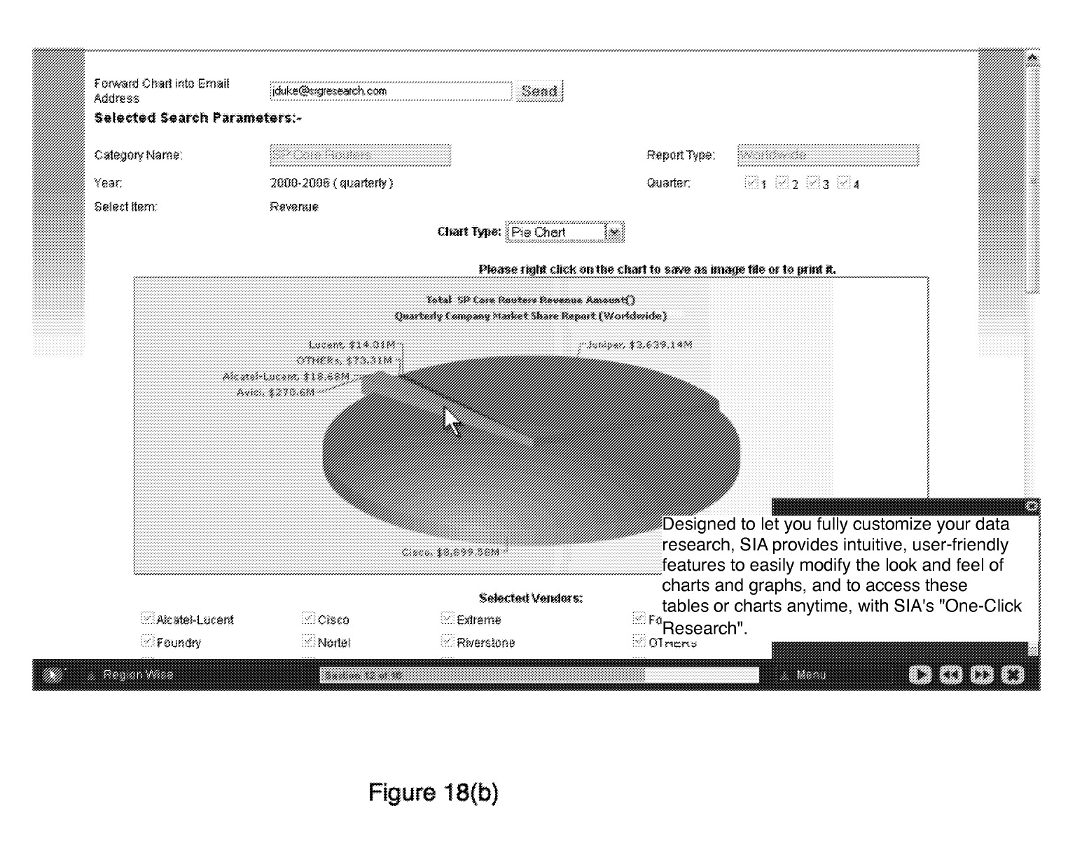

Referring to FIGS. 18(a) and 18(b) is shown how one feature, One-Click Research, available within the charts or graphs provides for interaction with the graphs. For example, pie charts may be rotated, or specific parts of a chart may be accessible for further information.

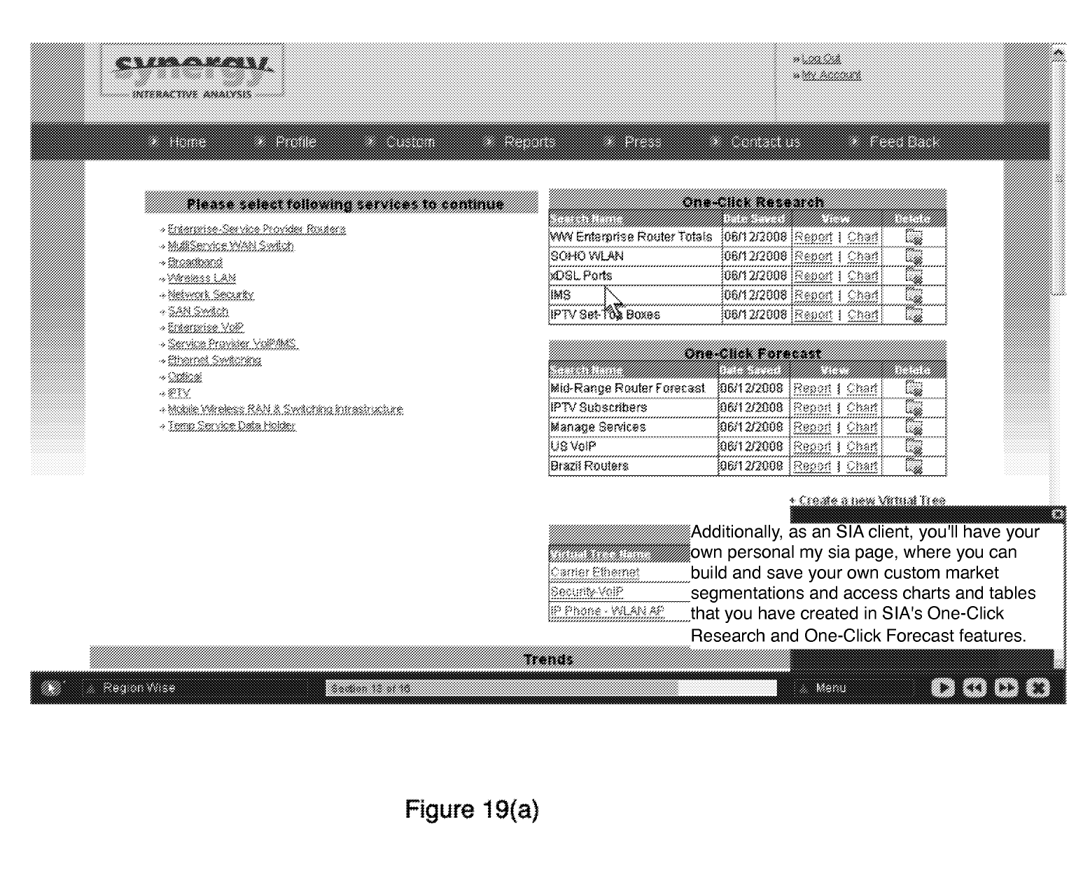

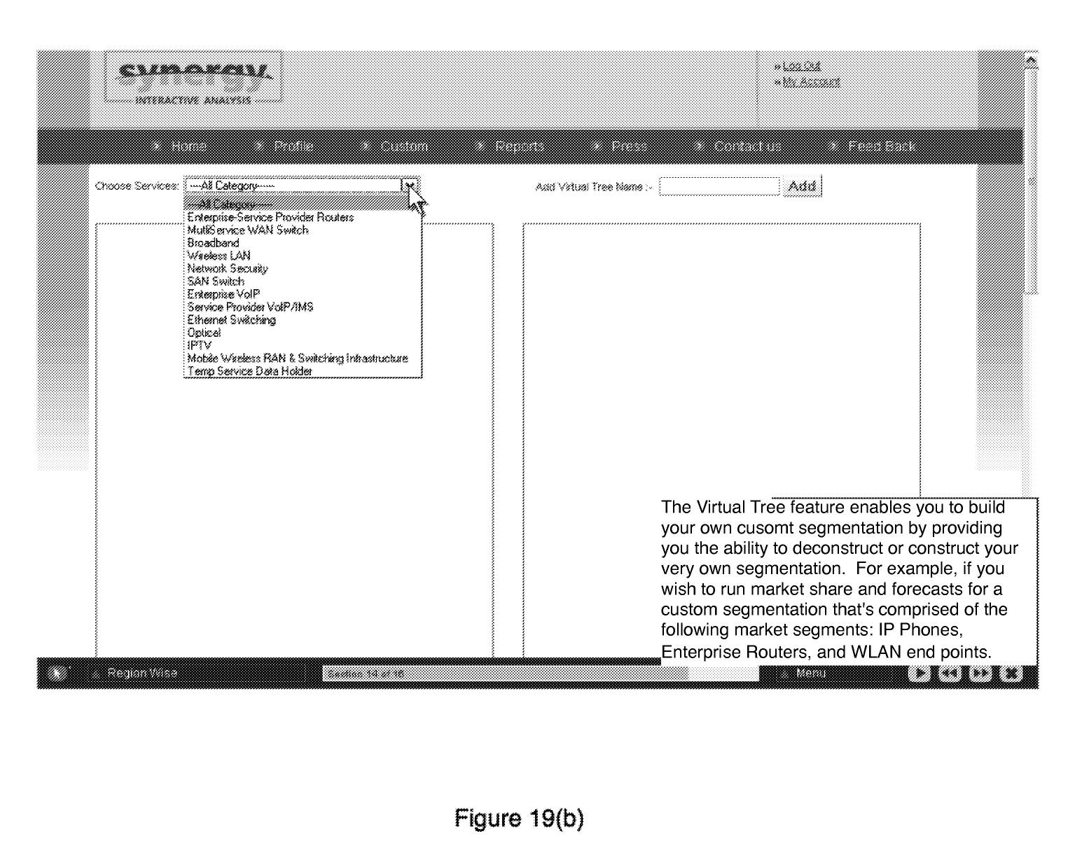

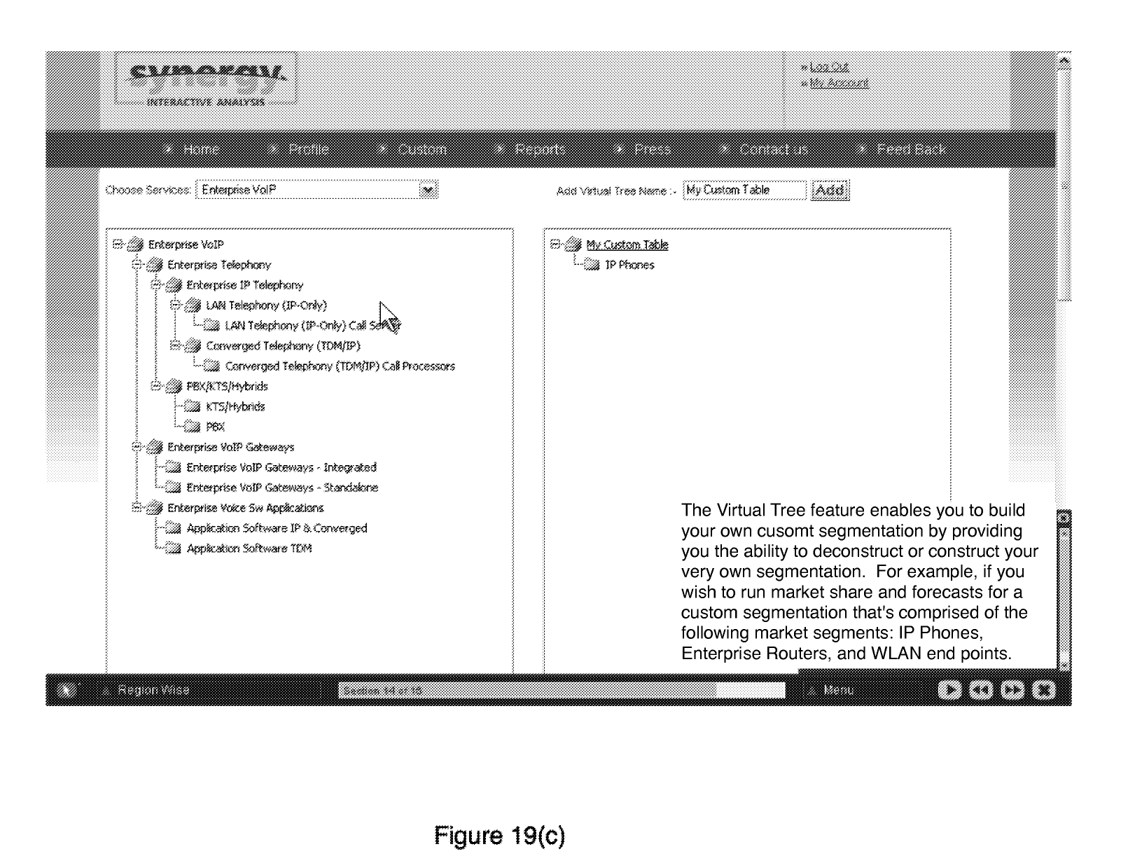

Referring now to FIGS. 19(a), 19(b), and 19(c) is shown how customized market segmentations of data may be built and saved for access and re-access. Choosing from specific categories provides additional options for obtaining valuable results. As a feature, the ability to build “Virtual Trees” to build custom segmentation of market data is a very powerful analytic tool.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

The invention claimed is:

1. A method for providing quantitative market share data over a computer network from a vendor to a subscriber, comprising the steps of:
Providing a subscriber with secure access to a custom market share research environment, said custom market share research environment comprising an interactive graphical user interface for viewing quantitative market share data stored in a database, wherein said interactive graphical user interface comprises an access feature for accessing said data and a control feature for generating one or more customized views of said data, wherein said one or more customized views of said data is based upon one or more parameters selected by said subscriber, said parameters comprising quarterly data, yearly data, date-range presented data, individual company data, market segment data, entire market data, geographical region data, country data, revenue data, units data, and user-defined data; and,
Generating and publishing a dynamically interactive report based on said parameters of market share data in real time, wherein said subscriber obtains the report during a single access session.

2. The method of claim 1, further comprising wherein the method is a web-based application.

3. The method of claim 1, further comprising wherein the graphical user interface provides an e-mail feature for generating and publishing a report to an e-mail address, and wherein the report to an e-mail address comprises interactive features for dynamically interacting with said report.

4. The method of claim 1, wherein said report is published as a dynamically interactive graph to provide trend analysis.

5. The method of claim 1, further comprising wherein said report is saved to a subscriber profile and is re-accessible during a later access session.

6. The method of claim 1, further comprising wherein said user-defined data is a customized market definition selected by the subscriber.

7. A system for providing quantitative market share data over a computer network from a vendor to a subscriber, the system comprising a server comprising a computer readable medium comprising program instructions executable by the server to:
Provide an interface configured to provide a subscriber with secure access to a custom market share research environment, said custom market share research environment comprising an interactive graphical user interface for viewing quantitative market share data stored in a database on the server, wherein said interactive graphical user interface comprises an access feature for accessing said data and a control feature for generating one or more customized views of said data, wherein said one or more customized views of said data is based upon one or more parameters selected by said subscriber, said parameters comprising quarterly data, yearly data, date-range presented data, individual company data, market segment data, entire market data, geographical region data, country data, revenue data, units data, and user-defined data; and,
Generate and publish a dynamically interactive report based on said parameters of market share data in real time, wherein said subscriber obtains the report during a single access session.

8. The system of claim 7, wherein the program instructions are further executable by the server to provide the interface and report generation as a web-based application.

9. The system of claim 7, wherein the program instructions are further executable by the server to provide an e-mail feature for generating and publishing a report to an e-mail address as part of the graphical user interface, and wherein the report to an e-mail address comprises interactive features for dynamically interacting with said report.

10. The system of claim 7, wherein the program instructions are further executable by the server to provide the published report as a dynamically interactive graph to provide trend analysis.

11. The system of claim 7, wherein the program instructions are further executable by the server to provide the report saved to a subscriber profile and re-accessible during a later access session.

12. The system of claim 7, wherein the program instructions are further executable by the server to provide wherein said user-defined data is a customized market definition selected by the subscriber.
